(19) United States
(12) Patent Application Publication
(10) Pub. No.: US 2026/0309182 A1
(43) Pub. Date: Oct. 8, 2026

(54) WASHER, NUT, AND FASTENING STRUCTURE

(71) Applicant: NIPPON PLARAD CO., Kobe-shi, Hyogo (JP)

(72) Inventor: Hiroshi Saeki, Kobe-shi, Hyogo (JP)

(73) Assignee: NIPPON PLARAD CO., Kobe-shi, Hyogo (JP)

(21) Appl. No.: 19/483,383

(22) PCT Filed: May 11, 2023
(86) PCT No.: PCT/JP2023/017748

§ 371 Date: Nov. 11, 2025

(51) Int. Cl. F16B 39/282; F16B 37/04; F16B 43/00

(52) U.S. Cl. CPC F16B 39/282; F16B 37/041; F16B 43/00

(57) ABSTRACT

Not only loosening can be prevented with a simple structure, and the manufacturing cost is inexpensive, but also loosening can be easily made when desired.

A nut 1 is screwed into a screw rod 4 penetrating an attachment object 3 and comes into contact with an attachment surface 3a of the attachment object 3. A nut body 1a in which at least one concave portion 1b having a circular cross section is provided on a surface on the attachment object 3 side, and a steel ball 2 rollably provided in the concave portion 1b of the nut body la are provided. The concave portion 1b is an inclined surface having a flat bottom surface and having a size that allows rolling of the steel ball 2, has a depth at which the entire steel ball 2 is stored in the concave portion 1b at the rear end portion in the nut loosening direction, and has a depth at which a part of the steel ball 2 protrudes from the concave portion 1b at the tip end portion in the nut loosening direction.

### TECHNICAL FIELD

The present invention relates to a washer, a nut, and a fastening structure.

### BACKGROUND ART

Various nuts and washers that are less likely to be loosened against vibration have been devised, but many of them have a complicated shape and structure or require expensive manufacturing cost. That is, as anti-loosening measures against vibration, many measures such as a method using a spring washer, a method using a double nut, and a method in which a split pin penetrates a nut and a bolt have been made, but sufficient effects have not been obtained.

Therefore, a lock pin mechanism has been proposed in which a lock pin is inserted into a hole provided in an inner surface of a nut to push and expand the inner surface of the nut to generate anti-loosening pressure (see, for example, Patent Literature 1).

Since the one described in Patent Literature 1 is fixed by pushing and spreading the inner surface of the nut, once the nut is loosened in the case of maintenance or the like, the threaded portion of the screw rod is damaged, and thus it is difficult to reuse the screw rod.

Further, as a lock washer, there has been proposed a lock washer in which an outer circumferential portion is flat, a central portion has a central hole into which a male screw can be inserted, a middle circumferential portion sandwiched between the central hole and the outer circumferential portion is divided into two or more equal parts, the division is connected to the central hole, the outer circumferential portion is radially divided into two or more equal parts by a notch from the central hole to the inside of the flat portion of the outer circumferential portion, one side of each notched surface is cut and raised, a nut anti-loosening locking piece is provided, and a divided fan-shaped portion has a nut anti-loosening locking piece formed in a conical surface of a disk spring shape (see, for example, Patent Literature 2).

In the one described in Patent Literature 2, the anti-loosening effect is improved by the anti-loosening by the elastic repulsive force of the lock washer and the wedge effect by the nut anti-loosening locking piece. However, the structure is complicated, such as cutting and raising one side of each notch surface and providing the nut anti-loosening locking piece, processing is difficult, and manufacturing cost becomes expensive. In addition, since the divided fan-shaped portion is formed in the conical surface of the disk spring shape, there is still a possibility that loosening occurs, and it is within a range of a function that it is hardly loosened. This is considered to be in a range in which the nut is not easily loosened because it is troublesome if the nut is not loosened.

Incidentally, there is also a proposal in which a steel ball is held in a long groove-shaped concave portion and rolled by a distance corresponding to a groove length of the long groove to expect a wedge effect (see, for example, Patent Literatures 3 and 4).

### CITATION LIST

### Patent Literature

Patent Literature 1: JP 2009-293793 A

Patent Literature 2: JP 2011-127752 A

Patent Literature 3: JP 59-19711 A

Patent Literature 4: JP 34-1413 U

### SUMMARY OF INVENTION

### Technical Problem

In the case described in Patent Literatures 3 and 4, the wedge effect is exhibited only after the nut rotates by a certain distance to exhibit the wedge effect before the wedge effect is exhibited, and thus it cannot be said that the wedge effect is practical. In other words, while the nut rotates by the certain distance, the nut is loosened by the amount corresponding to the certain distance, and the axial force of the bolt is lost.

More specifically, in the case of using the long groove-shaped concave portion, the inclined surface angle of the bottom surface of the concave portion does not function unless logically set to be larger than the “lead angle” of the screw of the nut, and the backlash increases because the wedge effect by the steel ball is exerted. That is, backlash is required for the steel ball to roll by the long groove length, and thus the bolt axial force is reduced by the backlash. Furthermore, the manufacturing cost increases.

An object of the present invention is to provide a washer, a nut, and a fastening structure that are not loosened with a simple structure, are inexpensive in manufacturing cost, and can be easily loosened when desired to be loosened.

### Solution to Problem

The present invention is a nut that is screwed into a screw rod penetrating an attachment object and comes into contact with a surface of the attachment object, the nut including a nut body in which at least one concave portion having a circular cross section is provided on a surface on the attachment object side, and a rolling element rollably held in the concave portion of the nut body, in which the concave portion has a size that allows rolling of the rolling element and a depth that becomes shallower in a nut loosening direction, a depth at which the entire rolling element is housed in the concave portion at a rear end portion in the nut loosening direction, and a depth at which a part of the rolling element protrudes from the concave portion at a tip end portion in the nut loosening direction. Here, the holding of the rolling element is not particularly limited, but for example, the surface of the rolling element can be magnetized (made into a magnet), the periphery of the concave portion can be caulked, an adhesive such as adhesive rubber glue can be used, or only the upper portion of the concave portion can be caulked so as not to affect the free rolling motion of the rolling element.

In this way, it is not loosened with a simple structure, the manufacturing cost is inexpensive, and it can be easily loosened when it is desired to loosen.

In this case, it is desirable that the rolling element is a steel ball and is harder than the nut body. Further, the bottom surface of the concave portion is a flat surface inclined at an angle θ along the circumferential direction when viewed from the nut center, and the angle θ is in a range of 0 to 45°.

Further, the present invention is a washer that is attached by being sandwiched between an attachment surface of an attachment object and a head of a nut or a bolt, the washer including a washer body, an annular convex portion provided on an upper side of the washer body and on a side in contact with a head of the nut or bolt and having a diameter equal to or smaller than an outer shape of the washer body, and at least one concave portion having a circular cross section, the concave portion being provided in the convex portion and rollably holding a rolling element, in which the concave portion has a size that allows rolling of the rolling element and a depth that becomes shallower in a nut or bolt loosening direction, a depth at which the entire rolling element is housed in the concave portion at a rear end portion in the nut or bolt loosening direction, and a depth at which a part of the rolling element protrudes from the concave portion at a tip end portion in the nut or bolt loosening direction.

In this case, it is desirable that the lower surface of the washer body is a concave surface having a curved surface shape gradually deepened toward the center.

In addition, as in the case of the nut described above, it is desirable that the rolling element be a steel ball and be harder than the nut body, and the concave portion be a flat surface whose bottom surface is inclined at an angle θ, and the angle θ be in the range of 0 to 45°.

A fastening structure according to the present invention is a fastening structure in which a nut is screwed into a screw rod penetrating an attachment object and the nut comes into contact with a surface of the attachment object, in which the nut is the nut according to any one of claims 1 to 3.

Another fastening structure according to the present invention is a fastening structure attached with a washer interposed between an attachment surface of an attachment object and a head of a nut or a bolt, in which the washer is the washer according to any one of claims 4 to 7.

### Advantageous Effects of Invention

The present invention does not loosen with a simple structure, and the manufacturing cost is inexpensive, and can be easily loosened when desired.

### BRIEF DESCRIPTION OF DRAWINGS

FIG. 1 is a diagram where a nut according to the present invention is assembled to a bolt.

FIG. 2 is a perspective view of the nut as viewed from a side in contact with a surface of an attachment object.

FIG. 3 is an explanatory view illustrating a relationship between a concave portion of the nut and a steel ball, in which (a) is a diagram as viewed from above the nut, (b) is a cross-sectional view when the steel ball is at a deep position of the concave portion, and (c) is a cross-sectional view when the steel ball is at a shallow position of the concave portion.

FIG. 4 is a diagram where the nut is actually assembled to a bolt.

FIG. 5 is an explanatory view illustrating a relationship between a concave portion of the nut and a steel ball, in which (a) is a diagram as viewed from above the nut, (b) is a diagram of a state in which the nut is tightened, (c) is a diagram where the nut is to be loosened, and (d) is a diagram in a case where a bottom surface is not inclined.

FIG. 6 is a diagram, in which (a) is a diagram of a state in which a steel ball is fitted in a concave portion of a nut, and (b) is a diagram illustrating the concave portion in a state in which the steel ball is loosened after being tightened and the steel ball is also removed.

FIG. 7 is a perspective view of a washer according to the present invention as viewed from above.

FIG. 8 is a diagram of a state in which the washer is disposed under a head of a bolt.

FIG. 9 is a perspective view of the washer as viewed from below.

FIG. 10 is an explanatory diagram illustrating a vibration testing device.

FIG. 11 is a diagram illustrating a result of a vibration comparison test.

### DESCRIPTION OF EMBODIMENTS

Hereinafter, embodiments according to the present invention will be described.

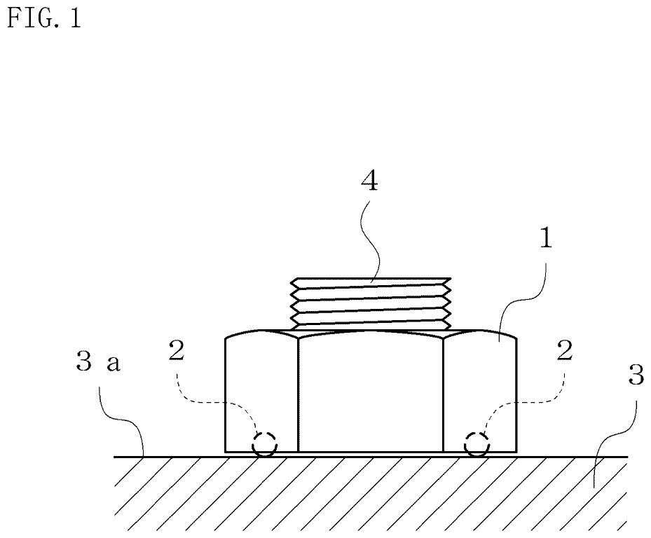

FIG. 1 is a diagram where a nut according to the present invention is assembled to a bolt.

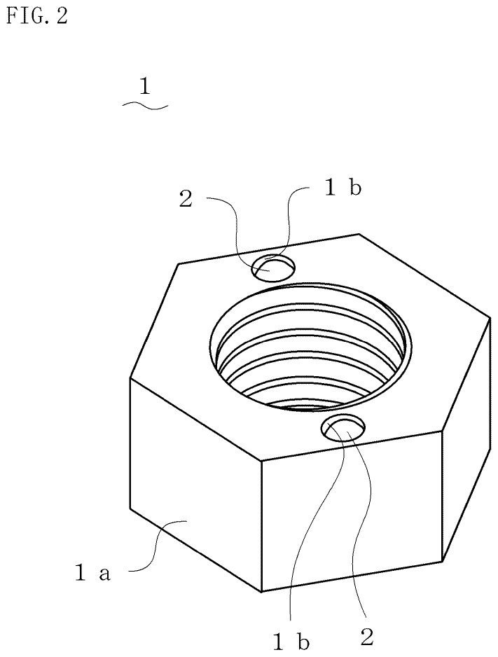

As illustrated in FIG. 1, a nut 1 is screwed into a screw rod 4 penetrating an attachment object 3, and a lower surface thereof is in contact with an attachment surface 3a (for example, a floor surface) of the attachment object 3. As illustrated in FIG. 2, the nut 1 includes a nut body la in which one or a plurality (two cases are illustrated in FIG. 1) of concave portions 1b having a circular cross section are provided on a lower surface which is a surface on the attachment object 3 side, and a steel ball 2 (rolling element) rollably held in the concave portion 1b of the nut body 1a. Incidentally, the steel ball 2 can be held so as not to protrude from the inside of the concave portion 1b by caulking the periphery of the opening portion of the concave portion 1b or using an adhesive such as adhesive rubber glue.

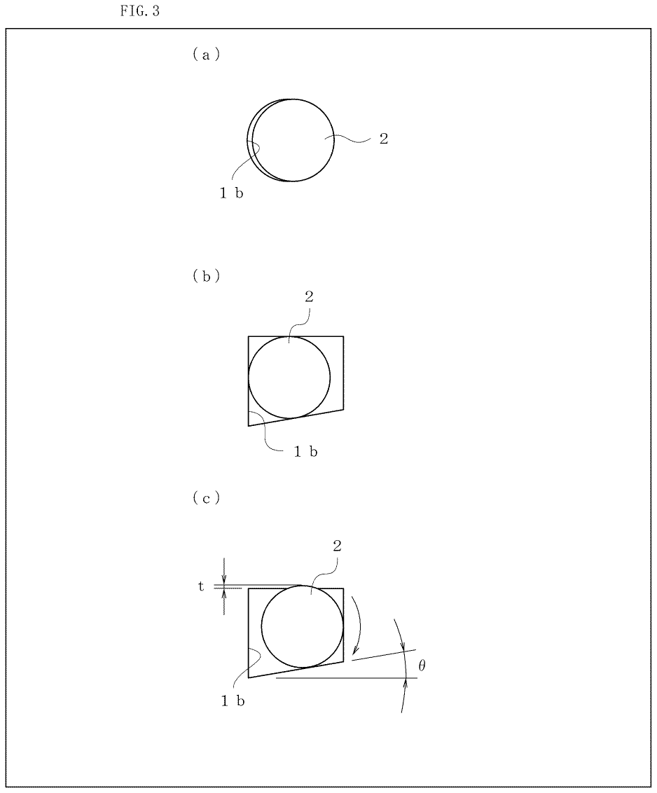

When viewed from above, as illustrated in FIG. 3(a), the concave portion 1b has a circular cross section, and is formed to have an inner diameter slightly larger than the diameter of the steel ball 2 to such an extent that the steel ball 2 can be smoothly and naturally inserted so that the steel ball 2 can roll in the concave portion 1b. For example, when the diameter of the steel ball 2 is φ 3/32 inch (=2.4 mm), if the inner diameter of the concave portion 1b is φ2.5 mm (the difference from the steel ball diameter is 0.1 mm), the relationship between the inner diameter of the concave portion 1b and the diameter of the steel ball 2 is sufficient for the steel ball 2 to be able to roll in the concave portion 1b. In addition, the steel ball 2 must be harder than the nut 1 in hardness so that the shape does not unintentionally collapse in the concave portion 1b. The steel ball 2 having a diameter of φ 3/32 inch (=2.4 mm) is a standard product that is frequently used for ball bearings and is a commercially available product that can be obtained at low cost.

As illustrated in FIG. 3(b) and 3(c), the bottom surface of the concave portion 1b is a flat surface (inclined surface) inclined at an angle θ. For example, in the concave portion illustrated in the front of FIG. 2, the left side of the concave portion is deeper, and the right side of the concave portion is shallower. The angle θ is not necessarily larger than the lead angle of the screw of the nut, and may be in the range of 0° to 45°. Here, in order to make the bottom surface of the concave portion 1b flat, for example, by inclining a nut, which is a workpiece, at a certain angle and drilling a hole with a flat drill from vertically above, it is possible to form a concave portion whose bottom surface is a flat surface inclined by the certain angle.

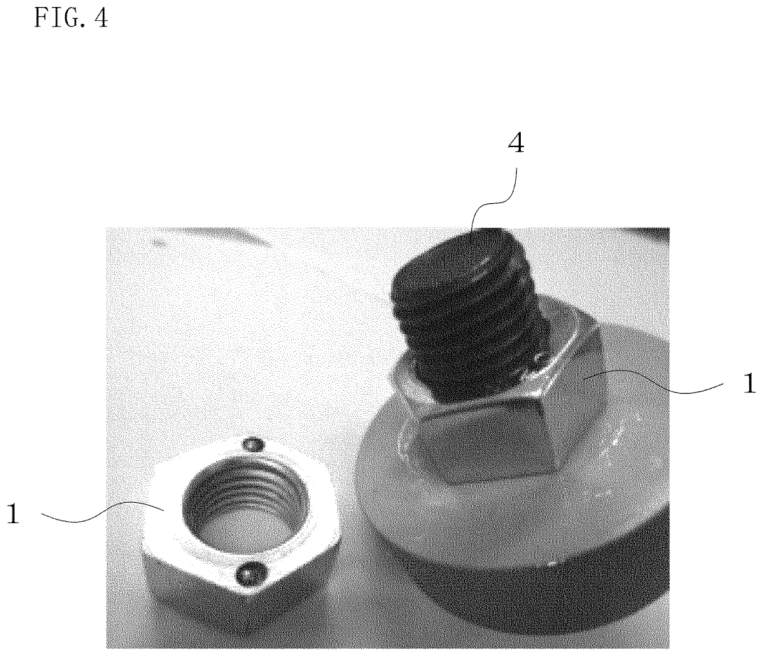

In addition, since the depth of the concave portion 1b gradually decreases in the nut loosening direction, the steel ball 2 is at the deepest position at the rear end portion in the nut loosening direction, and at that position, the depth is the depth at which the entire steel ball 2 is accommodated (see FIG. 3(b)). In addition, the steel ball 2 is at the shallowest position at the tip end portion in the nut loosening direction, and has a depth (see FIG. 3(c)) at which a part of the steel ball 2 protrudes from the surface (lower surface) of the nut 1 by a slight distance t. Then, in a state where the nut 1 is actually assembled to the bolt (screw rod 4), for example, as illustrated in FIG. 4.

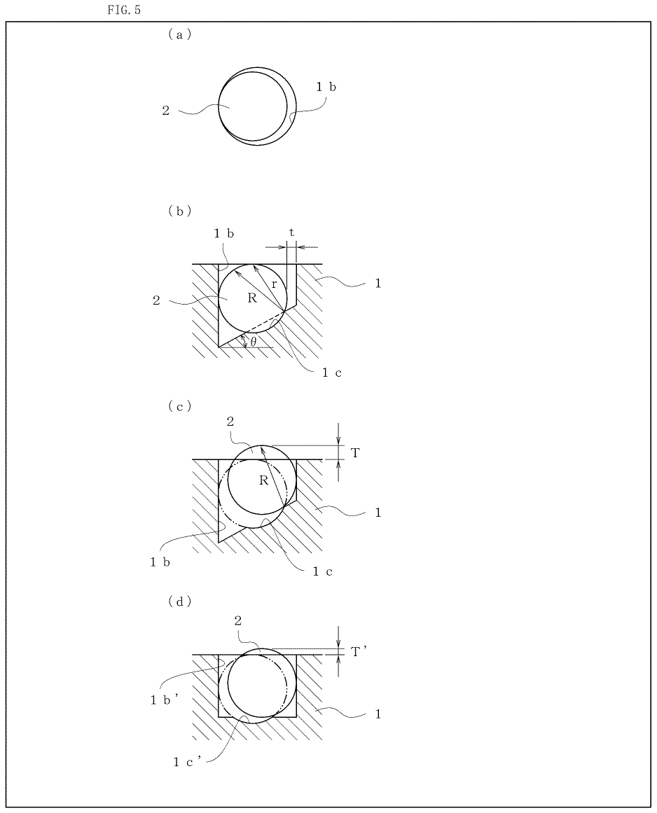

Next, the movement of the steel ball 2 will be described. When the state in which the steel ball 2 is held in the concave portion 1b of the nut 1 is viewed from above the concave portion 1b, as illustrated in FIG. 5(a), the inner diameter of the concave portion 1b is slightly larger than the diameter of the steel ball 2 so that the steel ball 2 can freely roll in the concave portion 1b.

In the state before tightening, the steel ball 2 is accommodated in the concave portion 1b, but when the nut 1 is tightened, the lower portion of the steel ball 2 is strongly pressed against the bottom surface (slope) of the concave portion 1b simultaneously with the tightening inside the concave portion 1b because the steel ball 2 is made harder than the nut 1. Then, as illustrated in FIG. 5(b), the steel ball 2 is pushed from the top to the bottom (that is, inward), and as a result, a round recess 1c corresponding to the shape of the steel ball 2 is formed on the bottom surface of the concave portion 1b by the steel ball 2.

When the nut 1 rotates in the nut loosening direction in response to the vibration, as illustrated in FIG. 5(c), the lower portion of the steel ball 2 is rubbed against the bottom surface of the concave portion 1b (the inner surface of the recess 1c) to approach the nut loosening direction (the right end of the concave portion 1b in FIG. 5(c) ), and the steel ball 2 moves to climb over the outer peripheral edge of the recess 1c. Since there is only a slight gap t between the steel ball 2 and the inner peripheral surface of the concave portion 1b and there is no sufficient space for the entire steel ball 2 to roll up, as a result, a distance r from the outer peripheral edge of the recess 1c as a starting point to the portion where the steel ball 2 rides up and rubs against the initial bottom surface changes to a distance R (see FIG. 5(b) and 5(c)). At this time, since the distance R is larger than the distance r, the upper portion (part) of the steel ball 2 protrudes from the nut surface by a distance T as illustrated in FIG. 5(c). Since this protruding portion functions as a so-called wedge between the nut 1 and the attachment object 3, the nut 1 does not move (does not rotate) and thus does not loosen.

Incidentally, FIG. 5(d) illustrates a case where the bottom portion of the concave portion 1b′ is a flat surface (=the inclination angle θ is 0°). In this case as well, the same function is exerted, and a part of the steel ball 2 protrudes by a distance T′, but since the position of the recess 1c′ of the concave portion 1b′ (the position of the outer peripheral edge serving as the starting point) is lower than that in the case of the slope described above, the protruding amount of the steel ball 2 becomes small, and the wedge effect is obtained but becomes weak. That is, as the oblique angle θ of the bottom surface of the concave portion 1b′ increases, the distance T increases, so that the wedge effect increases.

As described above, since the strength of the wedge effect (=anti-loosening effect of the nut) is determined by the magnitude of the oblique angle θ, the wedge effect is overcome by adjusting the angle θ to turn the nut 1 to the loosening side with 1.1 to 1.3 times the torque when the nut 1 is tightened. Therefore, it is possible to easily loosen without requiring a special tool.

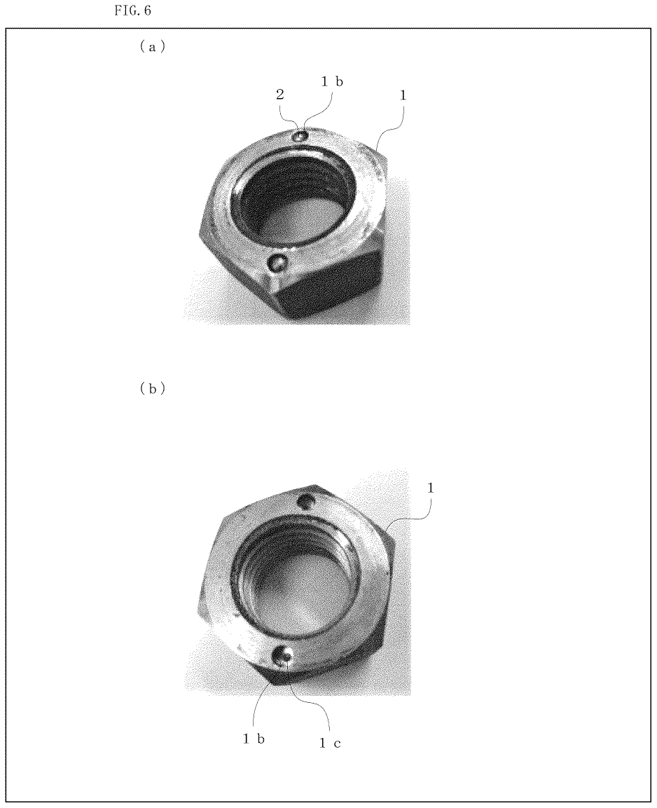

FIG. 6(a) illustrates the concave portion 1b in a state where the steel ball 2 is fitted in the concave portion 1b, and FIG. 6(b) illustrates the concave portion 1b in a state where the nut is loosened after being tightened and the steel ball 2 is also removed. It can be seen that a small recess 1c is formed at the bottom of the concave portion 1b. This is schematically illustrated in FIG. 5(b). In FIG. 6(a) and 6(b), a nut having a size M16 is used.

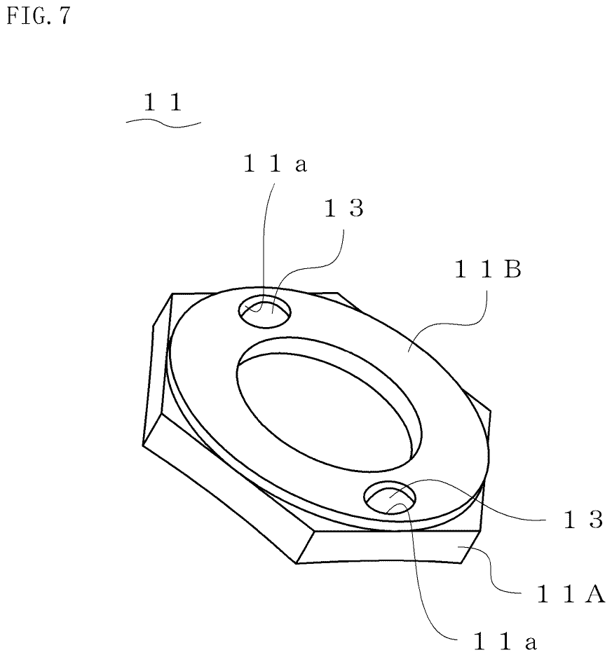

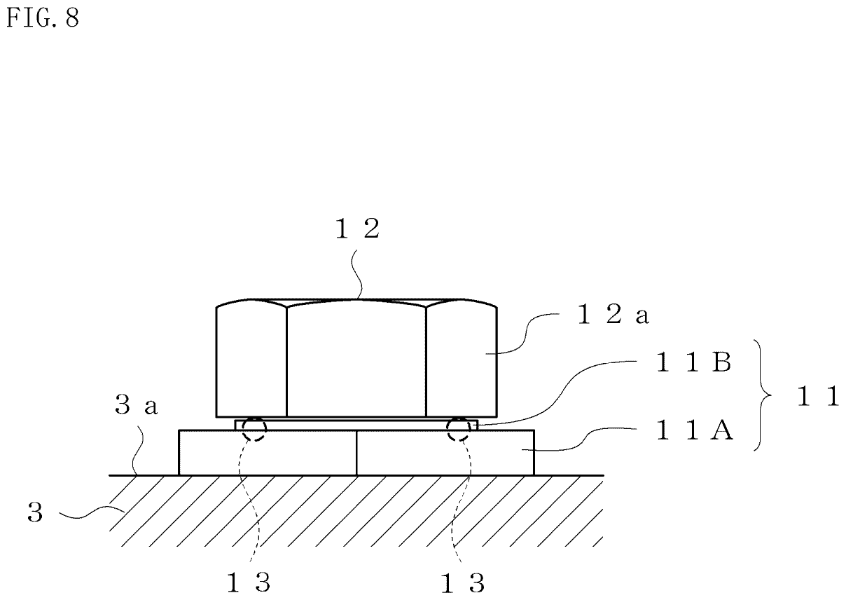

FIG. 7 illustrates a case where a locking structure (a structure having a concave portion and a steel ball on the washer surface) by a combination of a steel ball and a concave portion is applied to the washer surface, which is similar to the nut described above. As illustrated in FIG. 8, a washer 11 is used on the lower side of a head 12a of a bolt 12 in order to prevent rotation (prevent loosening) of the head 12a of the bolt 12, but may be provided on the lower side of the nut as an anti-loosening member for a normal nut.

The washer 11 has a hexagonal (or polygonal) outer shape, and as illustrated in FIGS. 7 and 8, a surface (upper surface) of a washer body 11A on a side in contact with the head 12a of the bolt 12 is provided with a circular convex portion 11B, one or a plurality of concave portions 11a are provided on the convex portion 11B, and a steel ball 13 is held in the concave portion 11a. The circular convex portion 11B is a circular step of a convex portion having an outer diameter equivalent to the parallel width of the head of the hexagonal bolt.

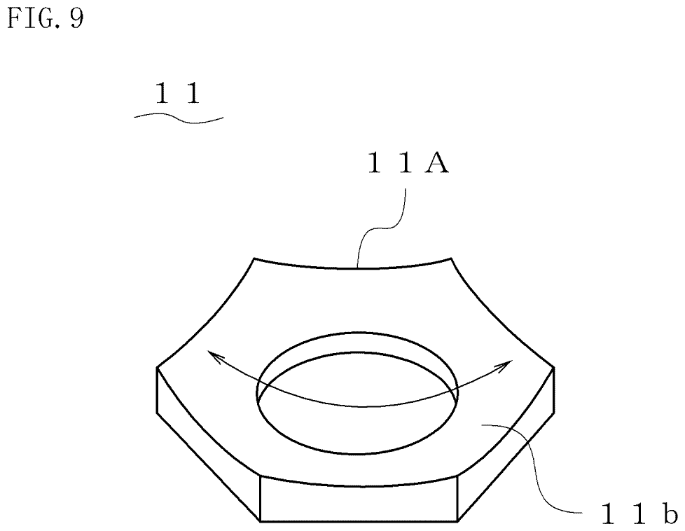

As illustrated in FIG. 9, the back surface (lower surface) in contact with the attachment surface 3a of the attachment object 3 (for example, a floor) is a curved concave surface 11b (for example, a conical concave surface) that gradually deepens toward the center (central hole). The washer outer shape may be a polygonal shape (or may be a circular shape), but FIGS. 7 to 9 illustrate a case where the washer outer shape is a hexagonal shape.

In the case of using such a washer 11, when receiving vibration, the head 12a of the bolt 12 rotates and starts to loosen. At this time, when the washer 11 rotates together, the wedge effect does not work, and the loosening prevention function is not exhibited. The reason why the washer 11 does not cause accompanying rotation is that the effective friction diameter of the rear surface (attachment object 3) of the washer 11 is larger than the effective friction diameter of the bolt 12 on the head 12a side. That is, the reason why the head 12a of the bolt 12 slides on the upper surface of the washer 11 (the upper surface of the convex portion 11B) and the lower surface of the washer 11 does not slide with respect to the attachment surface 3a at all is as follows. As described in JP 2021-179250 A, the frictional force between the head 12a of the bolt 12 and the washer 11 and the frictional force between the washer 11 and the attachment surface 3a are not related to the size of the area of the contact portion, but are the same as each other only by the pressing force of the head 12a of the bolt 12. Since both the head 12a of the bolt 12 with which the washer 11 is in contact and the attachment object 3 are made of iron and made of the same material, it is considered that a friction coefficient μ1 of the head 12a of the bolt 12 is substantially equal to a friction coefficient μ2 of the attachment object 3 even if there is a slight difference in the friction coefficients. Therefore, eventually, the frictional forces become equal.

On the other hand, in a case where the head 12a of the bolt 12 is tightened (the same applies to a case where the head is loosened), whether the washer 11 causes accompanying rotation depends on a difference in magnitude between a rotational force (torque) for rotating the washer 11 and a rotational resistance force (torque) acting so that the washer 11 does not rotate with respect to the attachment surface 3a. Therefore, by providing the curved concave surface 11b, a rotational resistance force F2 acting so that the washer 11 does not rotate with respect to the attachment surface 3a is made larger than a rotational force F1 to rotate the washer 11 by the frictional force between the head 12a of the bolt 12 and the washer 11. As described above, by providing the curved concave surface 11b, a length R2 (radius) from the rotation center to the contact portion between the washer 11 and the attachment surface 3a is larger than a length R1 from the rotation center to the contact portion between the bolt 12 and the washer 11, and even if the frictional force is the same, the rotational resistance force F2 of the washer 11 is larger than the rotational force F1 by which the bolt 12 attempts to rotate the washer 11. As a result, only the bolt 12 rotates without rotating the washer 11.

In addition, by forming the lower surface of the washer 11 into the curved concave surface 11b, the effective diameter of the contact portion with the attachment surface 3a is further increased, and by forming the outer shape of the washer 11 into the polygonal shape, the effect that each corner portion of the washer 11 gets stuck in the attachment surface 3a is added, and the washer 11 is prevented from further rotating even when receiving vibration. Note that if the outer shape of the washer is made polygonal and the outer size is made sufficiently large, the effective friction diameter is further increased, so that it is also possible to form a circular shape as an ultimate infinite polygon.

On the other hand, in the case of the concave portion having a circular cross section of the present invention, the inclination angle of the bottom of the concave portion does not necessarily have to be larger than the lead angle of the screw, and the function is exhibited even at 0°, there is almost no backlash, and the axial force does not decrease. As described above, since only holes are drilled with a flat drill, the manufacturing cost is low and the economic effect is 1arge. As compared with the case where the principle of exerting the wedge effect is a long groove, it has been confirmed that the effect of twice or more is exerted under vibration under the same conditions as the vibration comparison test results described later.

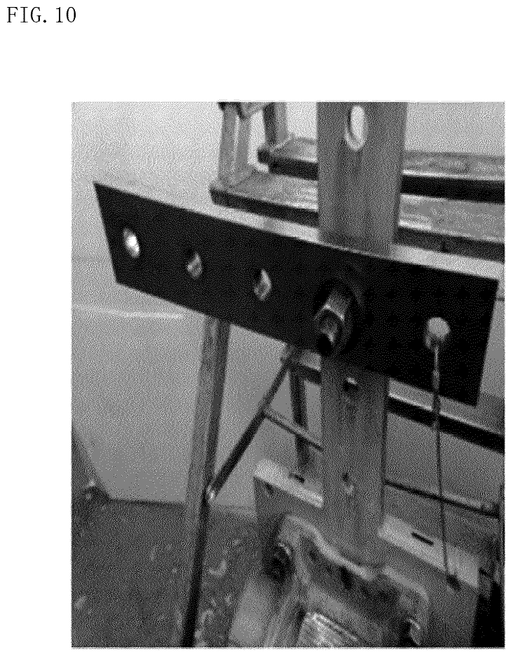

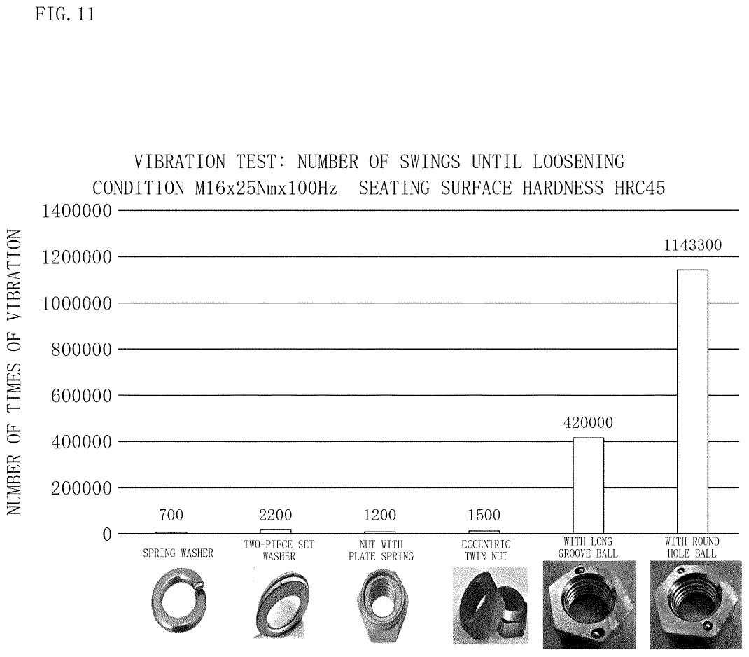

Actually, a nut of M16 is used, the inclination angle of the bottom surface is the same, that is, the angle θ is set to 5°, the inner diameter of the concave portion is set to 2.5 mm and the steel ball diameter is set to 2.38 mm in the case of a concave portion having a circular cross section, and the groove length is set to 3 mm in the case of a long groove, and a plurality of trial products are made, and a vibration comparison test is performed using a vibration testing device (see FIG. 10), and the result is illustrated in FIG. 11.

FIG. 11 is an average of several tens of vibration tests performed on each product for comparison, including other common anti-loosening products. Conceptually describing the strength of this vibration condition (=M16/tightening torque 25 Nm/frequency 100 Hz), it is an intense vibration that starts to loosen in several seconds (corresponding to several hundred vibrations) in the case of a “normal nut” without taking anti-loosening measures. In FIG. 11, among the two products on the right side, the left is a long groove and the right is a concave portion having a circular cross section.

These two products are both far superior in function to other anti-loosening products, but when the two products are compared, the number of times is 420,000 (in the case of the long groove) and the number of times is 1 million or more (in the case of the concave portion having a circular cross section), and the difference in effect is clear. In the case of the long groove, the anti-loosening effect is inferior to that of the concave portion having a circular cross section by about 42% (the number of vibrations until loosening is reduced by about 58%).

### REFERENCE SIGNS LIST

1 nut
1a nut body
1b concave portion
1c recess
2 steel ball
3 attachment object
3a attachment surface
4 screw rod
11 washer
11A washer body
11B convex portion
11a concave portion
11b curved concave surface
12 bolt
12a head of bolt
13 steel ball

1. A nut that is screwed into a screw rod penetrating an attachment object and comes into contact with a surface of the attachment object, the nut comprising:
a nut body in which at least one concave portion having a circular cross section is provided on a surface on the attachment object side; and
a rolling element rollably held in the concave portion of the nut body,
wherein the concave portion has a size that allows rolling of the rolling element and a depth that becomes shallower in a nut loosening direction, a depth at which the entire rolling element is housed in the concave portion at a rear end portion in the nut loosening direction, and a depth at which a part of the rolling element protrudes from the concave portion at a tip end portion in the nut loosening direction.

2. The nut according to claim 1, wherein the rolling element is a steel ball and is harder than the nut body.

3. The nut according to claim 1, wherein the concave portion is a flat surface whose bottom surface is inclined at an angle θ, and the angle θ is in a range of 0 to 45°.

4. A washer that is attached by being sandwiched between an attachment surface of an attachment object and a head of a nut or a bolt, the washer comprising:
a washer body;
an annular convex portion provided on an upper side of the washer body and on a side in contact with a head of the nut or bolt and having a diameter equal to or smaller than an outer shape of the washer body; and
at least one concave portion having a circular cross section, the concave portion being provided in the convex portion and rollably holding a rolling element,
wherein the concave portion has a size that allows rolling of the rolling element and a depth that becomes shallower in a nut or bolt loosening direction, a depth at which the entire rolling element is housed in the concave portion at a rear end portion in the nut or bolt loosening direction, and a depth at which a part of the rolling element protrudes from the concave portion at a tip end portion in the nut or bolt loosening direction.

5. The washer according to claim 4, wherein the lower surface of the washer body is a concave surface having a curved surface shape gradually deepened toward a center.

6. The washer according to claim 4, wherein the rolling element is a steel ball and is harder than the washer body.

7. The washer according to claim 4, wherein the concave portion is a flat surface whose bottom surface is inclined at an angle θ, and the angle θ is in a range of 0 to 45°.

8. A fastening structure in which a nut is screwed into a screw rod penetrating an attachment object and the nut comes into contact with a surface of the attachment object,
wherein the nut is the nut according to claim 1.

9. A fastening structure attached with a washer interposed between an attachment surface of an attachment object and a head of a nut or a bolt,
wherein the washer is the washer according to claim 4.
